(19) United States
(12) Patent Application Publication
(10) Pub. No.: US 2007/0065189 A1
(43) Pub. Date: Mar. 22, 2007

(54) Fixing device and image forming apparatus

(75) Inventors: Toshiyuki Miyata, Kanagawa (JP); Motofumi Baba, Kanagawa (JP); Daisuke Yoshino, Kanagawa (JP); Chikara Ando, Kanagawa (JP); Yasushi Kawahata, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/354,001

(22) Filed: Feb. 15, 2006

(30) Foreign Application Priority Data
Sep. 22, 2005 (JP) P2005-276797

(51) Int. Cl. G03G 15/20

(52) U.S. Cl. 399/323; 399/329

(57) ABSTRACT

A fixing device which fixes a toner image borne on a recording medium includes a rotatable fixing roll member, a rotatable tension roll member, a rotating fixing belt member stretched between the fixing roll member and the tension roll member, a heater which heats the fixing belt member, a pressing member which presses a portion of the fixing roll member around which the fixing belt member is wound to form a nip part, and a belt moving direction changing member which is interposed between the fixing belt member and the fixing roll member on a downstream side of the nip part, and changes a moving direction of the fixing belt member. Width “Wbe” of the fixing belt member, width “Wpr” of the pressing member, and width “Wpe” of the belt moving direction changing member are set to satisfy the following relation: Wpr≦Wbe<Wpe.

### CROSS-REFERENCE TO RELATED APPLICATIONS

This application is based upon and claims the benefit of priority from the prior Japanese Patent Applications No. 2005-276797, filed on Sep. 22, 2005, the entire contents of which are incorporated herein by reference.

### BACKGROUND OF THE INVENTION

1. Field of the Invention

The invention relates to a fixing device for use in an image forming apparatus of electrophotographic method, and more particularly to a fixing device having a rotatable belt member.

2. Description of the Related Art

In an image forming apparatus of electrophotographic method, such as a copying machine or a printer, image formation is performed in the following way. First of all, the surface of a photosensitive body (photosensitive drum) formed like the drum is uniformly charged by a charging unit. The charged photosensitive drum is scanned and exposed to the light controlled based on the image information to form an electrostatic latent image on its surface. Subsequently, the electrostatic latent image formed on the photosensitive drum is made a visible image (toner image) by a developing device, and then carried to a transfer part along with the rotation of the photosensitive drum, and electrostatically transferred on the recording paper as the recording medium. And the toner image borne on the recording paper is subjected to a fixing process by the fixing device, whereby the image is completed.

In general, the fixing device for use in this image forming apparatus employs a configuration called a two roll method. The fixing device of the two roll method has a fixing roll in which a heat resistant elastic layer and a releasing layer are laminated on the surface of a cylindrical core metal with a heating source (heater) disposed inside, and a pressing roll in which a heat resistant elastic layer and a releasing layer of heat resistant resin film or heat resistant rubber film are laminated on a core metal, both rolls being pressed and contacted with each other. And the toner image is fixed by passing the recording paper with the unfixed toner image borne through a pressure contact area (nip part) between the fixing roll and the pressing roll to heat and press the unfixed toner image.

By the way, in recent years, the image forming apparatuses have suddenly advanced for higher productivity and coloration, and are often provided with a perfect printing mechanism. Therefore, it is required that the fixing device mounted on the image forming apparatus can further cope with the high speed operation.

However, the related-art fixing device of two roll method has a problem that it is difficult to make a sufficient fixing process for a large number of recording sheets forwarded in succession at high speed. That is, in the fixing device of two roll method, the core metal making up the fixing roll and the elastic layer made of silicone rubber and covered on the core metal act as a thermal resistor. Therefore, in the fixing device of two roll method, it is structurally difficult to supply a quantity of heat corresponding to the quantity of heat, of which the recording paper deprives the surface of the fixing roll, from the heater disposed inside the fixing roll promptly and sufficiently.

As a result, if the recording sheets are forwarded in succession to the fixing device of two roll method at high speed, inconveniently, the surface temperature of the fixing roll decreases gradually, so that the fixing performance degrades. At the starting time of the image forming apparatus, a so-called “temperature droop phenomenon” that the surface temperature of the fixing roll temporarily falls is more likely to occur. Especially when the cardboard with large thermal capacity is employed as the recording paper, the quantity of heat taken from the surface of the fixing roll is increased, so that the fixing performance is lower or the temperature droop is greater, causing deterioration in the image quality due to fixing failure.

In these circumferences, there has been developed a technology for realizing the fixing device corresponding to the high speed of the image forming apparatus by solving the above-mentioned problem associated with the fixing device of two roll method. For instance, there is a technique concerning the fixing device in which the heating member that heats the recording paper is composed of a film-like belt member (fixing belt) stretched around two or more tension rolls (e.g., refer to JP-A-3-133871).

In the fixing device using such fixing belt, the fixing belt is sufficiently preheated by a heater disposed within the tension roll before entering the nip part, and the toner image is fixed in the nip part by applying heat from the heated fixing belt to the recording paper and the toner image. Therefore, even if the fixing belt is deprived of heat by the recording paper during the fixing process, the fixing belt can be recovered up to a prescribed fixable temperature in a short time by the heater within the tension roll, because the thermal capacity of the fixing belt itself is small. Thereby, the fixing device employing the fixing belt as the heating member is easy to maintain the temperature of the fixing belt in entering the nip part at a prescribed value, whereby even if the image forming apparatus is sped up, a sufficient quantity of heat can be supplied to the nip part.

However, in the fixing device employing the fixing belt, since the toner image is borne on the surface of the recording paper, when the toner image melts due to heat of the fixing belt, the toner image becomes adhesive to exert an adhesion between the recording paper and the fixing belt. Therefore, there is a need for a mechanism that peels the recording paper from the surface of the fixing belt, like the related-art fixing device of two roll method. Especially when the image forming apparatus is sped up, it is required to peel the recording paper passing through the nip part fast from the fixing belt side stably and surely, because once the fixing device has a peeling failure to cause a paper clog (jam), a number of recording sheets may be subsequently damaged under the influence of the jam.

The mechanism that peels the recording paper from the surface of the fixing belt generally has a configuration in which a separation claw is disposed in contact with the fixing belt on the downstream side of the nip part, as described in JP-A-3-133871.

However, in the configuration in which the recording paper is peeled from the surface of the fixing belt by the separation claw, especially when the fixing was made at high speed, the tip of the recording paper collided against a peeling claw to damage the tip, and in the worst case, cause the paper jam occasionally. This trouble is likely to occur for the recording paper especially with a small thickness.

To peel the recording paper from the fixing belt stably by preventing such trouble, it is required to press the separation claw against the fixing belt strongly. However, there is fear that the surface of the fix belt is worn out by the separation claw. If the surface of the fixing belt is worn out, the image quality may be degraded because the unevenness of fixing corresponding to wear-out on the surface of the fixing belt arises on the fixed image. Also, the offset toner may be gradually deposited on the wear-out to cause a blemish on the fixed image. Further, if the wear on the surface of the fixing belt progresses, the fixing belt of thin layer is finally broken, whereby the high durability can not be obtained.

Thus, to peel the recording paper from the fixing belt stably without employing such separation claw, a configuration has been proposed in which a peeling member for setting the curvature of the fixing belt at the exit to a large value is provided inside the fixing belt at a position corresponding to the exit (most downstream side) of the nip part, to enable the recording form to be peeled owing to a change in the curvature of the fixing belt (e.g., refer to JP-A-2003-5566).

JP-A-3-133871 (page 4, FIG. 3) and JP-A-2003-5566 (pages 6-8, FIG. 4) are referred to as related art.

As described above, in the configuration in which the peeling member for increasing the curvature of the fixing belt is provided at the exit of the nip part, thereby enabling the recording paper to be peeled from the surface of the fixing belt, the fixing belt slidingly contacts the secured peeling member. In the case where the peeling member is pressed and contacted with the pressing roll to partially form the nip part, if there is a gap between the nip part formed by the fixing roll and the pressing roll and the nip part formed by the peeling member and the pressing roll, a pressure contact force may drop in its gap portion to cause an image defect due to occurrence of blister. To avoid such trouble, the peeling member is provided as close to the fixing roll as possible. As a result, there is a problem that the wear of the fixing belt or the pressing roll sliding with the peeling member may affect the fixing performance, whereby the high fixing performance is not maintained for the long term,.

For instance, the fixing roll, the pressing roll and the peeling member are set in equal width orthogonal to the moving direction of the recording paper, and the width of the fixing belt is set to be narrower. In this case, there occurs an area where the peeling member and the pressing roll are directly contacted and slid outside the fixing belt, so that the pressing roll is only worn out in that area. Consequently, the pressing roll has a step to cause a running failure of the fixing belt, or fixing unevenness.

### SUMMARY OF THE INVENTION

The invention is achieved to address the above-mentioned technical problems, and provides a fixing device using a belt member, and an image forming apparatus, in which the high fixing performance is maintained for the long term by preventing wear of the fixing belt or the pressing roll due to the peeling member to have an adverse influence on the fixing performance.

According to an aspect of the present invention, a fixing device which fixes a toner image borne on a recording medium includes a rotatable fixing roll member, a rotatable tension roll member, a rotating fixing belt member stretched between the fixing roll member and the tension roll member, a heater which heats the fixing belt member, a pressing member which presses a portion of the fixing roll member around which the fixing belt member is wound to form a nip part, and a belt moving direction changing member which is interposed between the fixing belt member and the fixing roll member on a downstream side of the nip part, and changes a moving direction of the fixing belt member. Width “Wbe” of the fixing belt member, width “Wpr” of the pressing member, and width “Wpe” of the belt moving direction changing member are set to satisfy the following relation: Wpr≦Wbe<Wpe.

According to another aspect of the present invention, a fixing device which fixes a toner image borne on a recording medium includes a rotatable fixing roll member, a rotatable tension roll member, a rotating fixing belt member stretched between the fixing roll member and the tension roll member, a pressing roll member which presses a portion of the fixing roll member around which the fixing belt member is wound to form a nip part, the pressing roll member having an elastic layer on its surface, and a bending member formed of metal which is interposed between the fixing belt member and the fixing roll member on a downstream side of the nip part, and bends the fixing belt member at a greater curvature. The bending member and the pressing roll member are not directly contacted owing to the belt member interposed between the bending member and the pressing roll member, even when the fixing belt member walks.

According to still another aspect of the present invention, an image forming apparatus includes a toner image forming section which forms a toner image, a transfer section which transfers the toner image formed by the toner image forming section onto a recording medium, and a fixing device which fixes the toner image transferred onto the recording medium on the recording medium. The fixing device includes a rotatable fixing roll member, a rotatable tension roll member having a thermal heater, a rotating fixing belt member stretched between the fixing roll member and the tension roll member, a pressing roll member which presses a portion of the fixing roll member around which the fixing belt member is wound to form a nip part, the pressing roll member having an elastic layer on its surface, and a peeling member which is interposed between the fixing belt member and the fixing roll member on a downstream side of the nip part, and peels the recording medium from the fixing belt member. Width “Wbe” of the fixing belt member, width “Wpr” of the pressing roll member, and width “Wpe” of the peeling member are set to satisfy the following relation: Wpr≦Wbe<Wpe.

According to still another aspect of the present invention, a fixing device which fixes a toner image borne on a recording medium includes a rotational member, an endless belt member which is wound around the rotational member and rotates along with a rotation of the rotational member, a pressing member which presses the rotational member and the belt member wound around the rotational member to form a nip part, and a belt moving direction changing member which is interposed between the belt member and the rotational member on a downstream side of the nip part, and changes a moving direction of the belt member. Wdth “Wbe” of the belt member, width “Wpr” of the pressing member, and width “Wpe” of the belt moving direction changing member are set to satisfy the following relation: Wpr≦Wbe<Wpe.

### BRIEF DESCRIPTION OF THE DRAWINGS

FIG. 1 is a schematic configurational view of an image forming apparatus according to an exemplary embodiment of the invention;

FIG. 2 is a perspective view conceptually showing one end portion of a fixing device;

FIG. 3 is a cross-sectional side view showing a schematic configuration of the fixing device;

FIG. 4 is a schematic cross-sectional view showing a neighboring area of the nip part;

FIG. 5 is a schematic cross-sectional view showing the periphery of an area where a peeling pad is disposed;

FIG. 6 is a conceptual view of the fixing device, as seen from the paper exhausting side; and

FIG. 7 is an explanatory view of the belt walk.

### DETAILED DESCRIPTION OF THE PREFERRED EMBODIMENTS

Embodiments of the invention will be described below in detail with reference to the accompanying drawings.

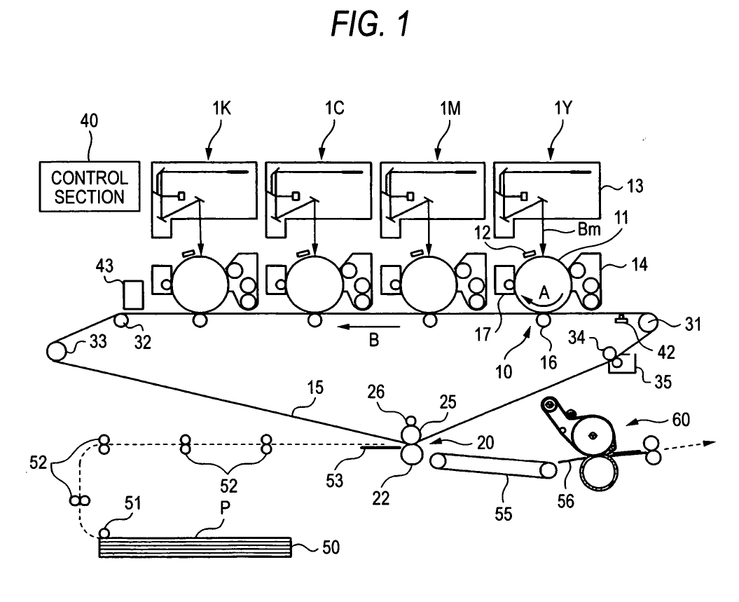

FIG. 1 is a schematic configurational view of an image forming apparatus according to an exemplary embodiment of the invention.

The image forming apparatus as shown in FIG. 1 is of a so-called tandem type using an intermediate transfer method, having plural image forming units 1Y, 1M, 1C and 1K as the toner image forming having for forming the toner image of each color component by electrophotography, the primary transfer units 10 for sequentially transferring (primary transfer) the toner image of each color component formed by each of the image forming units 1Y, 1M, 1C and 1K onto an intermediate transfer belt 15, a secondary transfer unit 20 as the transferring having for collectively transferring (secondary transfer) the superposed toner images transferred onto the intermediate transfer belt 15 onto a recording paper P as the recording medium, and a fixing device 60 for fixing the secondarily transferred image on the recording paper P. A control unit 40 for controlling the operation of each unit (each part) is provided.

Each of the image forming units 1Y, 1M, 1C and 1K has a charging unit 12 for charging a photosensitive drum 11, a laser exposing unit 13 for writing an electrostatic latent image on the photosensitive drum 11 (exposing beam is designated by sign Bm in the figure), a developing unit 14, containing the toner of each color component, for developing the electrostatic latent image on the photosensitive drum 11 into a visible image with the toner, a primary transfer roll 16 for transferring the toner image of each color component formed on the photosensitive drum 11 onto an intermediate transfer belt 15 in the primary transfer unit 10, and a drum cleaner 17 for removing the residual toner on the photosensitive drum 11, in which these electrophotographic devices are disposed in due order around the photosensitive drum 11 rotated in a direction of the arrow A. The image forming units 1Y, 1M, 1C and 1K are arranged almost linearly in the order of yellow (Y), magenta (M), cyan (C) and black (K) from the upstream side of the intermediate transfer belt 15.

The intermediate transfer belt 15 is stretched around various rolls in a passage extending almost linearly along a direction where the photosensitive drums 11 are arranged, and circularly driven (rotated) at a prescribed speed in a direction of the arrow B as indicated in FIG. 1.

The primary transfer unit 10 is composed of the primary transfer roll 16 disposed opposite to the photosensitive drum 11 with the intermediate transfer belt 15 sandwiched. The primary transfer roll 16 presses and contacts the intermediate transfer belt 15 with the photosensitive drum 11. Also, a voltage (primary transfer bias) of reverse polarity to the charging polarity of the toner is applied to the primary transfer roll 16. Thereby, the toner images on the photosensitive drums 11 are sequentially sucked electrostatically to the intermediate transfer belt 15, and superposed on the intermediate transfer belt 15.

The secondary transfer unit 20 has a secondary transfer roll 22 arranged on the side of a toner image bearing face of the intermediate transfer belt 15, and a backup roll 25 disposed opposite to the secondary transfer roll 22 with the intermediate transfer belt 15 interposed.

A secondary transfer bias is applied to the backup roll 25, and the secondary transfer roll 22 is grounded, whereby a secondary transfer bias is generated with the backup roll 25. And the toner image is secondarily transferred onto the recording sheet P conveyed to the secondary transfer unit 20.

An intermediate transfer belt cleaner 35 for cleaning the surface of the intermediate transfer belt 15 by removing the residual toner or paper powder on the intermediate transfer belt 15 after secondary transfer is provided at the downstream side of the secondary transfer unit 20 on the intermediate transfer belt 15.

Further, the image forming apparatus has a recording paper conveying mechanism 50. The recording paper conveying mechanism 50 conveys the recording paper P from a recording paper tray 51 accommodating the sheets of recording paper P to the secondary transfer unit 20, and conveys the recording paper P where the toner image is transferred (secondarily transferred) in the secondary transfer unit 20 to the fixing device 60.

The image forming apparatus of the above configuration forms the image in the following way.

That is, each of the image forming units 1Y, 1M, 1C and 1K forms the toner image of each color on each photosensitive drum 11 based on the image data outputted from an image reader, not shown, or a personal computer, not shown. The formation of the toner image on each of the image forming units 1Y, 1M, 1C and 1K is performed in such a way that the laser exposing unit 13 scans and exposes the photosensitive drum 11 charged by the charging unit 12 to form an electrostatic latent image and the developing unit 14 develops the electrostatic latent image to form the toner image.

The toner image formed on the photosensitive drum 11 of each of the image forming units 1Y, 1M, 1C and 1K is transferred and superposed on the intermediate transfer belt 15 in the primary transfer unit 10.

The toner images superposed on the surface of the intermediate transfer belt 15 are moved to the secondary transfer unit 20 along with the revolution of the intermediate transfer belt 15, and collectively transferred electrostatically onto the recording paper P conveyed by the recording paper conveying mechanism 50 in this secondary transfer unit 20.

The recording paper P, onto which the toner images are transferred, is conveyed to the fixing device 60 by the recording paper conveying mechanism 50, and the toner images are fixed on the recording paper P through a fixing process with heat and pressure by the fixing device 60. And the recording paper P on which the image is fixed is exhausted to a paper output tray (not shown) provided in an exhausting portion of the image forming apparatus.

The fixing device 60 for use in the image forming apparatus according to this embodiment will be described below.

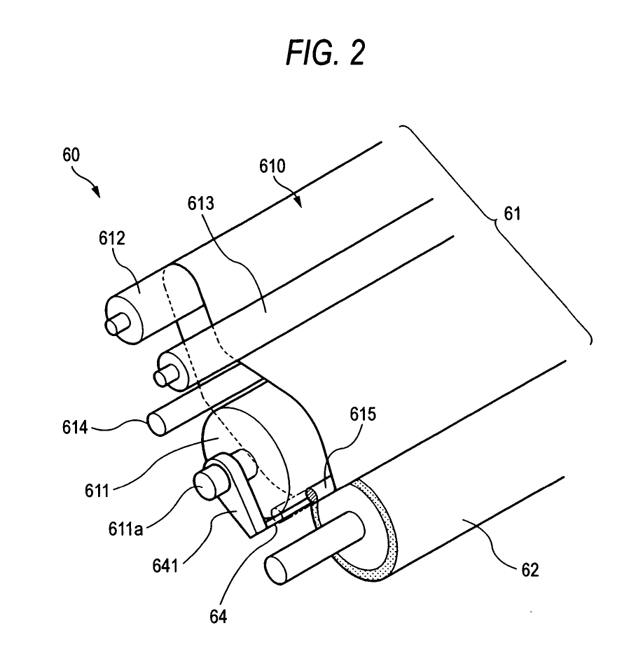

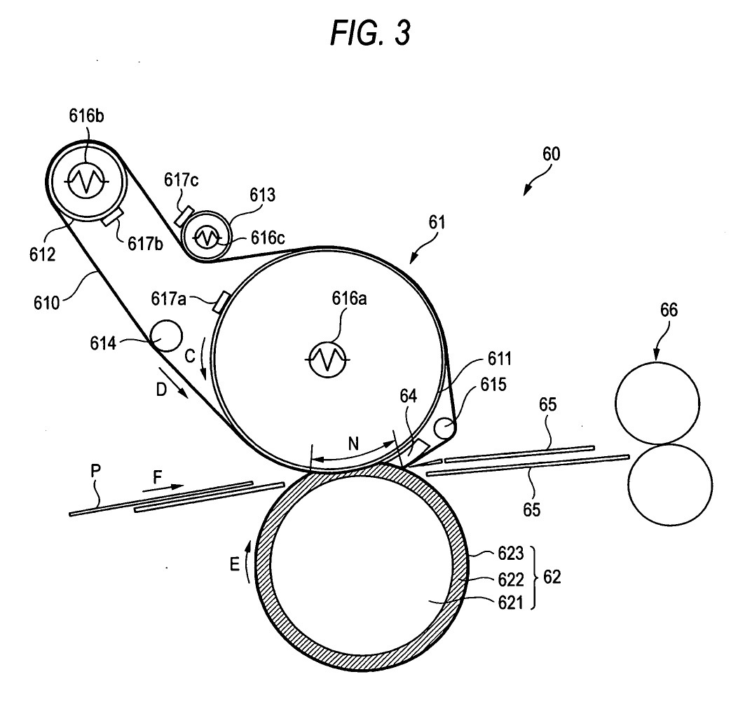

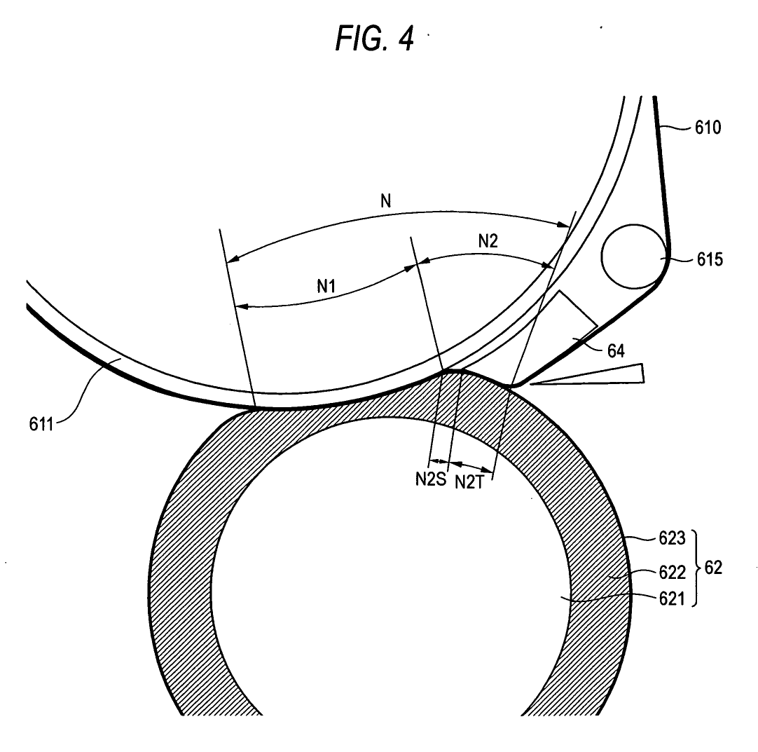

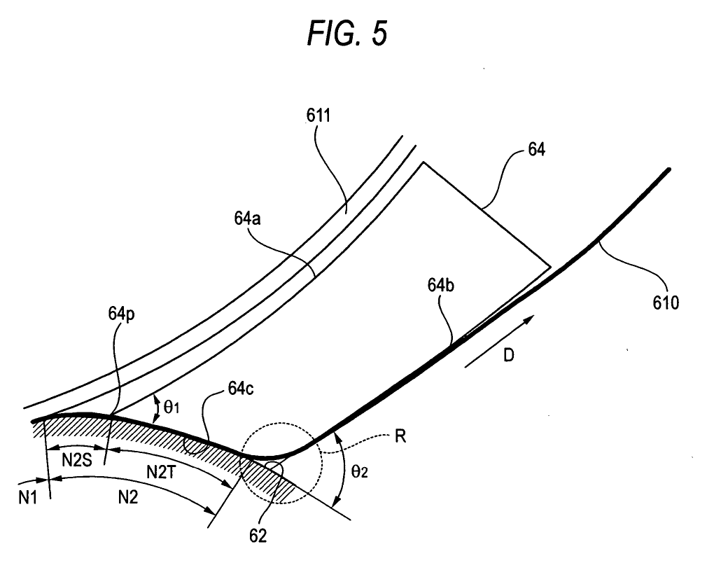

FIG. 2 is a perspective view conceptually showing one end portion of the fixing device 60 according to this embodiment. FIG. 3 is a schematic cross-sectional side view showing a configuration of the fixing device 60. FIG. 4 is a schematic cross-sectional view showing a neighboring area of the nip part N. FIG. 5 is a schematic cross-sectional view showing the periphery of an area where a peeling pad 64 is disposed.

This fixing device 60 has a fixing belt module 61 having a fixing belt 610, and a pressing roll 62 as the pressing having pressed and contacted with the fixing belt module 61.

The fixing belt module 61 has, as the main components, a fixing belt 610 as a belt member, a fixing roll 611 as a fixing roll member that rotates while stretching the fixing belt 610, a tension roll 612 as a tension roll member for stretching the fixing belt 610 from the inside, a tension roll 613 as a tension roll member for stretching the fixing belt 610 from the outside, an attitude correction roll 614 as the walk section for adjusting the attitude of the fixing belt 610 between the fixing roll 611 and the tension roll 612, a peeling pad 64 as a peeling member disposed at a position near the fixing roll 611 in a downstream region within a nip part N where the fixing belt module 61 and the pressing roll 62 are pressed and contacted, and a tension roll 615 as a tension roll member for stretching the fixing belt 610 on the downstream side of the nip part N.

The fixing belt 610 is a flexible endless belt having a peripheral length of 314 mm and a width of 340 mm. And the fixing belt 610 is composed of a base layer formed of polyimide resin having a thickness of 80 μm, an elasticity layer made of silicone rubber having a thickness of 200 μm, which is laminated on the surface (outer peripheral face) of the base layer, and a releasing layer formed of tetrafluoroethylene-perfluoroalkylvinylether copolymer resin (PFA) tube having a thickness of 30 μm, which is covered on the elasticity later. Herein, the elasticity layer is provided to improve the image quality of the color image in particular. The configuration of the fixing belt 610 is appropriately chosen in terms of material, thickness and hardness according to the apparatus designs including use purposes or use conditions.

The fixing roll 611 is a hard roll having a cylindrical core roll (core metal) made of aluminum and having an outer diameter of 65 mm, a length of 360 mm and a thickness of 10 mm, around which a fluororesin film having a thickness of 200 μm is covered as a protective layer for protecting the surface of the core roll from metal wear. The fixing roll 611 is not limited to this configuration, but may have any other configuration as far as it is hard enough to cause less deformation against a pressure from the pressing roll 62 in forming the nip part N with the pressing roll 62. And the fixing roll 611 is rotated at a surface rate of 440 mm/s in a direction of the arrow C due to a driving force from a drive rotor, not shown.

A halogen heater 616a having a rating of 900 W is disposed as the heating having inside the fixing roll 611. The control unit 40 (see FIG. 1) of the image forming apparatus controls the surface temperature of the fixing roll 611 to be 150° C., based on a measured value of a temperature sensor 617a disposed in contact with the surface of the fixing roll 611.

The tension roll 612 is a cylindrical roll formed of aluminum and having an outer diameter of 30 mm, a thickness of 2 mm and a length of 360 mm. And a halogen heater 616b having a rating of 1000 W is disposed as a heating source inside the tension roll 612, of which the surface temperature is controlled to be 190° C. by a temperature sensor 617b and the control unit 40 (see FIG. 1). Accordingly, the tension roll 612 has a function of heating the fixing belt 610 from the inner peripheral face, as well as a function of stretching the fixing belt 610.

Also, a spring member (not shown) for biasing the fixing belt 610 outwards is disposed at either end of the tension roll 612, so that the overall tension of the fixing belt 610 is set at 15 kgf. To make the tension of the fixing belt 610 uniform over the width direction and suppress the axial displacement of the fixing belt 610 as much as possible, the tension roll 612 is formed in a so-called crown shape in which the outer diameter is 100 μm larger in the central portion than at the end portion.

The tension roll 613 is a cylindrical roll formed of aluminum and having an outer diameter of 25 mm, a thickness of 2 mm and a length of 360 mm. Also, a releasing layer made of fluororesin and having a thickness of 20 μm is formed on the surface of the tension roll 613. This releasing layer is formed to prevent a little offset toner or paper powder from the outer peripheral face of the fixing belt 610 from being deposited on the tension roll 613. Also, the tension roll 613, like the tension roll 612, is formed in a crown shape in which the outer diameter is 100 μm larger in the central portion than at the end portion. Both the tension roll 612 and the tension roll 613 are formed in the crown shape, but either the tension roll 612 or the tension roll 613 may be formed in the crown shape.

A halogen heater 616c having a rating of 1000 W is disposed as the heating having inside the tension roll 613, of which the surface temperature is controlled to be 190° C. by a temperature sensor 617c and the control unit 40 (see FIG. 1). Accordingly, the tension roll 613 has a function of heating the fixing belt 610 from the outer peripheral face, as well as a function of stretching the fixing belt 610. Accordingly, the fixing belt 610 is heated by the fixing roll 611, the tension roll 612 and the tension roll 613 in this embodiment.

An attitude correction roll 614 is a columnar roll formed of aluminum and having an outer diameter of 15 mm and a length of 360 mm. A belt edge position sensing mechanism (not shown) for sensing the edge position of the fixing belt 610 is disposed near the attitude correction roll 614. And the attitude correction roll 614 is provided with an axial displacement mechanism for displacing the contact position in the axial direction of the fixing belt 610 in accordance with the sensed result of the belt edge position sensing mechanism to control the belt walk of the fixing belt 610.

The peeling pad 64 is a block member formed of a rigid body made of metal or resin such as SUS, and having an almost circular arc cross-section. The peeling pad is supported at both ends by the arms 641 swingably fitted around a support shaft 611a of the fixing roll 611, as shown in FIG. 2. And the peeling pad is secured over the entire area in the axial direction of the fixing roll 611 at a neighboring position on the downstream side of an area (a “roll nip part N1”, see FIG. 4 on the latter stage) where the pressing roll 62 is pressed and contacted via the fixing belt 610 with the fixing roll 611. Also, the peeling pad 64 is placed to force the pressing roll 62 via the fixing belt 610 over a predetermined width area (e.g., a width of 5 mm along the moving direction of the fixing belt 610) uniformly at a prescribed load (e.g., 10 kgf), forming a “peeling pad nip part N2” as will be described later.

The peeling pad 64 is formed with an inner side face 64a facing the fixing roll 611, an outer side face 64b for suddenly changing the moving direction of the fixing belt 610, and a pressing face 64c for pressing the fixing belt 610 against the pressing roll 62, as shown in FIG. 5.

The inner side face 64a of the peeling pad 64 is formed with a curved face following the peripheral face of the fixing roll 611 to place the peeling pad 64 as close to the fixing roll 611 as possible (e.g., the gap between the peeling pad 64 and the fixing roll 611 is 0.5 mm). An upstream end portion 64p of the inner side face 64a is set at a position near the fixing roll 611. The angle θ1 made between the inner side face 64a and the pressing face 64c is preferably from 20 to 50° to assure the strength and rigidity of the upstream end portion 64p.

The pressing face 64c of the peeling pad 64 is the face pressing the fixing belt 610 against the pressing roll 62 and forcing the fixing belt into pressure contact with the surface of the pressing roll 62. Therefore, the pressing face 64c is formed planar so that the fixing belt 610 may be pressed uniformly against the pressing roll 62. Moreover, the pressing face 64c may be formed with a concave curved face following the circumferential face of the pressing roll 62, so that the pressing force can be more uniform.

The outer side face 64b of the peeling pad 64 is the face for peeling the recording paper P from the fixing belt 610 by conducting the fixing belt 610 in cooperation with the tension roll 615 and the fixing roll 611 to suddenly change its moving direction. Therefore, the angle θ2 (see FIG. 5) made between the tangential line of the pressing roll 62 and the tangential line of the outer side face 64b is set to be 40° or more in an upstream end area (area where the fixing belt 610 leaves from the pressing roll 62) R of the outer side face 64b so that the recording paper P may be peeled stably from the fixing belt 610. Also, the outer side face 64b is formed with a curved face in the upstream end area R so that the fixing belt 610 may be smoothly moved in the upstream end area R suddenly bent.

Further, the outer side face 64b is formed with a plane inclined toward the tension roll 615, so that the fixing belt 610 may smoothly move in the direction of the tension roll 615 and the fixing roll 611, after leaving from the pressing roll 62. In this case, the outer side face 64b may be formed with a face curved toward the outside (side of the fixing belt 610).

The tension roll 615 is a columnar roll formed of aluminum and having an outer diameter of 12 mm and a length of 360 mm. The tension roll 615 is disposed on the downstream side of the peeling pad 64 in the moving direction of the fixing belt 610, so that the fixing belt 610 passing through the peeling pad 64 may be rotated smoothly toward the fixing roll 611.

The pressing roll 62 is a soft roll having a columnar roll 621 formed of aluminum and having a diameter of 45 mm and a length of 360 mm as a base substance, and an elastic layer 622 made of silicone rubber with rubber hardness of 30° (JIS-A) and having a thickness of 10 mm and a releasing layer 623 formed from a PFA tube having a film thickness of 100 μm, which are laminated in order on the base substance. And the pressing roll 62 is placed to be pressed against the fixing belt module 61, and rotated in a direction of the arrow E, following the fixing roll 611, as the fixing roll 611 of the fixing belt module 61 is rotated in a direction of the arrow C. Its moving speed is 440 mm/s that is as fast as the surface speed of the fixing roll 611.

The nip part N where the fixing belt module 61 and the pressing roll 62 are pressed and contacted will be described below.

As shown in FIG. 4, in the nip part N where the fixing belt module 61 (see FIG. 3) and the pressing roll 62 are pressed and contacted, the pressing roll 62 is pressed and contacted with the outer peripheral face of the fixing belt 610 within an area (wrap area) where the fixing belt 610 is wound (wrapped) around the fixing roll 611, to form a roll nip part (first nip part) N1.

Herein, in the fixing device 60 of this embodiment, the fixing roll 611 that is one roll to form the roll nip part N1 is a hard roll composed of an aluminum core metal (core roll) covered with heat resistant resin (fluororesin) on the surface, in which no elastic layer is covered on the fixing roll 611. Also, the pressing roll 62 forming the roll nip part N1 is a soft roll covered with an elastic layer 622.

With such a configuration of the fixing roll 611 and the pressing roll 62, in the roll nip part N1 of this embodiment, the elastic layer 622 of the pressing roll 62 is deformed to form the roll nip part N1, whereby the pressing roll 62 functions as a roll forming the nip (NIP Forming Pressure Roll). That is, in the roll nip part N1, the fixing roll 611 is less depressed but the surface of the pressing roll 62 only is greatly depressed (depressed amount of the pressing roll 62>depressed amount of the fixing roll 611), thereby producing a nip area having a predetermined width in the moving direction of the fixing roll 610.

In this way, in the fixing device 60 of this embodiment, the fixing roll 611 on the side where the fixing belt 610 is wrapped is less deformed in the roll nip part N1 to maintain a cylindrical shape. Therefore, the fixing belt 610 is rotated along the circumferential face of the fixing roll 611, without changing its radius of revolution, and can pass through the roll nip part N1 while keeping the moving speed constant. Thereby, the fixing belt 610 is unlikely to have a wrinkle or distortion while passing through the roll nip part N1. As a result, an image disorder in the fixed image is suppressed, so that the fixed image of good quality can be provided stably. In the fixing device 60 of this embodiment, the roll nip part N1 is set to 15 mm ahead (i.e., nip width of 15 mm) in the moving direction of the fixing belt 610.

Moreover, the peeling pad 64 is disposed nearby on the downstream side of the roll nip part N1 to press the fixing belt 610 onto the surface of the pressing roll 62. Thereby, a peeling pad nip part (second nip part) N2 where the fixing belt 610 is wrapped around the surface of the pressing roll 62 is formed continuously to the roll nip part N1 on the downstream side of the roll nip part N1.

As shown in FIG. 4, the peeling pad 64 forming the peeling pad nip part N2 is formed in the shape of almost circular cross section, and disposed along the axial direction of the fixing roll 611 nearby on the downstream side of the roll nip part N1. And the fixing belt 610 after passing through the peeling pad nip part N2 is rotated following the side face of the peeling pad 64. Thereby, the moving direction of the fixing belt 610 is suddenly changed to be bent in the direction of the tension roll 615 by the peeling pad 64. Therefore, the recording paper P passing through the roll nip part N1 and the peeling pad nip part N2 can not follow a change in the moving direction of the fixing belt 610 at the time of exiting from the peeling pad nip part N2, so that the recording paper P is peeled from the fixing belt 610 due to its own “yoke”. In this way, the curvature dissociation for the recording paper P is stably made at the exit of the peeling pad nip part N2. In the fixing device 60 of this embodiment, the peeling pad nip part N2 is set to 5 mm ahead (i.e., nip width of 5 mm) in the moving direction of the fixing belt 610.

The fixing operation of the fixing device 60 according to this embodiment will be described below.

The recording paper P, onto which the unfixed toner image is electrostatically transferred in the secondary transfer unit 20 (see FIG. 1) of the image forming apparatus, is conveyed toward the nip part N (see FIG. 3, in the direction of the arrow F) of the fixing device 60 by the recording paper conveying mechanism 50 (see FIG. 1). And the unfixed toner image on the surface of the recording paper P passing through the nip part N is fixed on the recording paper P mainly due to pressure and heat exerted on the roll nip part N1.

At this time, in the fixing device 60 of this embodiment, the heat acting on the nip part N is supplied mainly by the fixing belt 610. The fixing belt 610 is heated by the heat supplied through the fixing roll 611 from the halogen heater 616a disposed inside the fixing roll 611, the heat supplied through the tension roll 612 from the halogen heater 616b disposed inside the tension roll 612, and the heat supplied through the tension roll 613 from the halogen heater 616c disposed inside the tension roll 613. Therefore, since thermal energy is replenished from the tension roll 612 and the tension roll 613 to the fixing belt 610 appropriately and promptly, a sufficient quantity of heat can be kept in the nip part N even if the process speed is as fast as 440 mm/s.

The recording paper P, after passing through the roll nip part N1, is conveyed to the peeling pad nip part N2. The peeling pad nip part N2 is formed so that the peeling pad 64 may be pressed against the pressing roll 62 and the fixing belt 610 may be contacted with the pressing roll 62. Accordingly, the roll nip part N1 has a curved shape of convex downward owing to the curvature of the fixing roll 611, while the peeling pad nip part N2 has a curved shape of convex upward owing to the curvature of the pressing roll 62, as shown in FIG. 4.

Therefore, the recording paper P heated and pressurized with the curvature of the fixing roll 611 in the roll nip part N1 is changed in the moving direction with the curvature in a direction opposite to the pressing roll 62 in the peeling pad nip part N2. At this time, a minute micro slip occurs between the toner image on the recording paper P and the surface of the fixing belt 610. Thereby, the adhesion between the toner image and the fixing belt 610 is weakened, so that the recording paper P is more likely to be peeled from the fixing belt 610. In this way, the peeling pad nip part N2 is also placed in a preparatory process to be securely peeled in the final peeling process.

Since the fixing belt 610 is conveyed to wind around the peeling pad 64 at the exit of the peeling pad nip part N2, the conveying direction of the fixing belt 610 is suddenly changed there. That is, since the fixing belt 610 is moved along the outer side face 64b of the peeling pad 64, the fixing belt 610 is greatly bent. Therefore, the recording paper P, in which the adhesion with the fixing belt 610 is weakened beforehand within the peeling pad nip part N2, can be peeled by itself from the fixing belt 610 owing to the yoke of the paper that the recording paper P itself has.

In this way, the recording paper P is separated stably from the fixing belt 610 due to curvature dissociation at the time of exiting from the peeling pad nip part N2.

And the recording paper P separated from the fixing belt 610 is exhausted out of the apparatus by a paper exhausting guide 65 and a paper exhausting roll 66, thereby completing the fixing process.

Herein, the widths of the fixing roll 611, the fixing belt 610, the pressing roll 62, and the peeling pad 64 in the direction orthogonal to the conveying direction of the recording paper P are set as follows. In this explanation, the length of the fixing roll 611, the pressing roll 62 and the peeling pad 64 in the width direction of the recording paper P is designated as “width” as a whole.

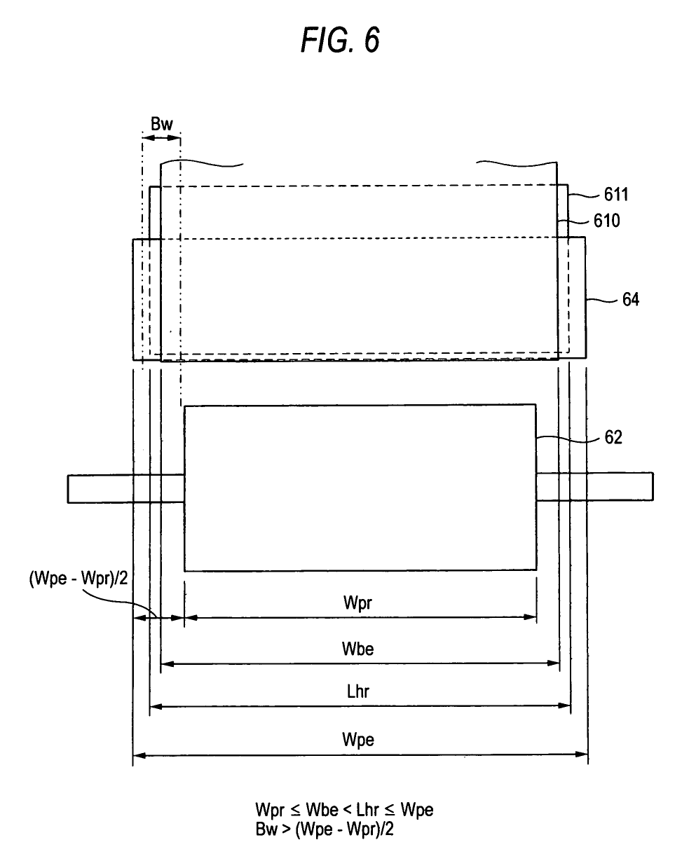

FIG. 6 is a conceptual view of the fixing device 60 as seen from the paper exhausting side. In the following, it is assumed that the width of the fixing roll 611 is “Lhr,” the width of the peeling pad 64 is “Wpe,” the width of the fixing belt 610 is “Wbe,” and the width of the pressing roll 62 is “Wpr.”

And the fixing roll 611, the peeling pad 64 and the fixing belt 610 are set up to satisfy the following relation.
Width of fixing belt: Wbe<width of fixing roll: Lhr≦width of peeling pad: Wpe Condition 1

Thereby, it is possible to prevent wear on the inner face of the fixing belt 610 due to the peeling pad 64 that is a metallic fixture member, and damage of the fixing belt 610 due to both edges of the peeling pad 64. Also, it is possible to prevent damage of the fixing belt 610 due to the side edge of the fixing roll 611.

Also, the peeling pad 64 and the pressing roll 62 are set up to satisfy the following relation.
Width of pressing roll: Wpr<width of peeling pad: Wpe Condition 2

Thereby, it is possible to prevent wear on the surface of the pressing roll 62 due to the peeling pad 64, and damage of the pressing roll 62 due to both edges of the peeling pad 64.

Moreover, the fixing belt 610 and the pressing roll 62 are set up to satisfy the following relation.
Width of pressing roll: Wpr≦width of fixing belt: Wbe Condition 3

Thereby, it is possible to prevent wear or damage on the surface of the pressing roll 62 because of the pressing roll 62 directly contacting and sliding with the peeling pad 64.

The above conditions 1, 2 and 3 are unified as
Wpr≦Wbe<Lhr≦Wpe Condition 4.

Thereby, it is possible to prevent wear or damage of the pressing roll 62 caused by directly contacting and sliding with the peeling pad 64. Also, it is possible to prevent wear or damage of the fixing belt 610 because of contacting and sliding with the side edge of the fixing roll 611 or the peeling pad 64. Accordingly, the durability of the fixing belt 610 or the pressing roll 62 is increased, high fixing performance is maintained for the long term, and the longer life of the fixing device 60 is enabled.

By the way, the fixing belt 610 is desirably kept rotated around the predetermined axial position of the fixing roll 611. However, it is not possible to avoid oblique motion due to accumulation of component errors or assembling errors of members making up the fixing device 60 or variable fixing conditions for the fixing device 60. Therefore, an axial displacement mechanism displaces the contact position of the attitude correction roll 614 (see FIG. 3) in the axial direction of the fixing belt 610 according to the sensed result of the belt edge position sensing mechanism, to control the belt walk of the fixing belt 610, as previously described. Thereby, the fixing belt 610 is rotated while walking within a predetermined axial range of the fixing belt 610. The fixing belt 610 may be formed wider by a predetermined amount than the required minimum, and caused to walk by a predetermined distance to avoid the fixing action at the same position, whereby the durability of the fixing belt 610 is improved.

In consideration of this belt walk, the fixing device may depart from the condition 4 by belt walk during the operation, even if the condition 4 is satisfied in the initialized state.

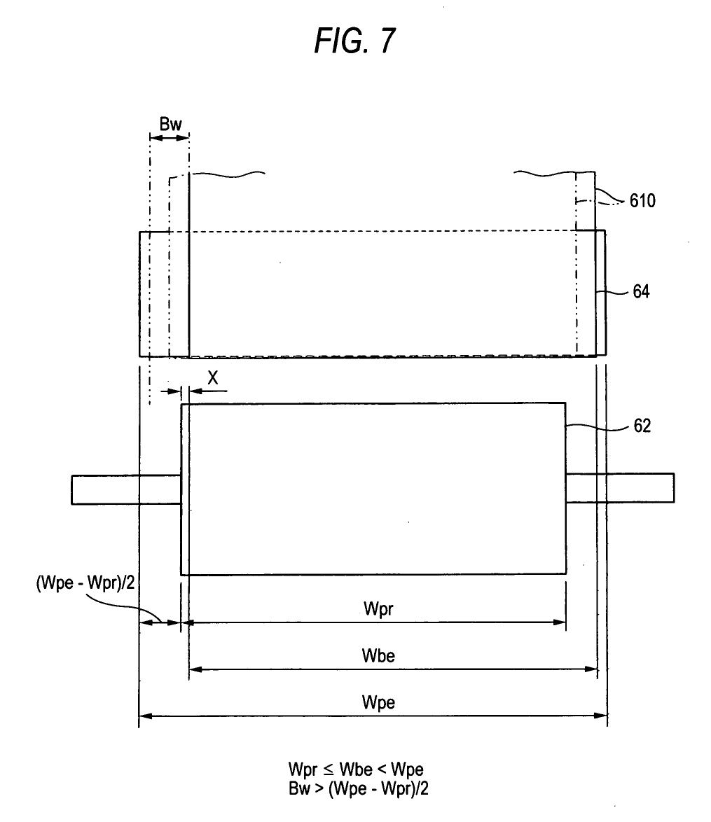

FIG. 7 is an explanatory view of this belt walk.

That is, even if the fixing belt 610 is interposed between the peeling pad 64 and the pressing roll 62 in the initialized state as shown in FIG. 6, the side edge of the fixing belt 610 moves closer to the center than the side edge of the pressing roll 62 owing to the walk of the fixing belt 610, possibly giving rise to an area (as indicated by X in FIG. 7) where the peeling ad 64 and the pressing roll 62 are directly contacted, as shown in FIG. 7,

Therefore, assuming that the maximum width of belt walk on one side is Bw from the initialized state in which all the centers are matched, as shown in FIG. 6, the fixing device is set to satisfy the following condition.
Bw<(width of peeling pad: Wpe−width of pressing roll: Wpr)/2 Condition 5

Thereby, even when the fixing belt 610 walks, the fixing belt 610 or the pressing roll 62 does not directly contact and slide with the peeling pad 64, whereby the durability of the fixing belt 610 or the pressing roll 62 is increased, the high fixing performance is maintained for the long term, and the longer life of the fixing device 60 is enabled.

An evaluation test was conducted for the configuration according to this embodiment (configurational example of this invention) and a comparative example to which this embodiment was not applied, and the results will be described below. The results are listed in Tables 1 and 2 below. Table 1 is the case of considering the belt walk, and Table 2 is the case of not considering the belt walk. In these tables, O indicates no occurrence of wear and damage, and x indicates occurrence of wear and damage.

TABLE 1

| | | Configurational |
|---|---|---|
| | Comparative | example of the |
| | Example | invention |
| | (Without walk) | (Without walk) |
| Wear and damage on inner face of | x | ∘ |
| fixing belt | | |
| Wear and damage on surface of | x | ∘ |
| pressing roll | | |

The configurational conditions and a test method are as follows.

Configurational example of the invention satisfying the above relational expression

Width of peeling pad: Wpe=380 mm

Width of fixing belt: Wbe=360 mm

Width of pressing roll: Wpr=340 mm

Comparative example not satisfying the above relational expression

Width of peeling pad; Wpe=340 mm

Width of fixing belt: Wbe=360 mm

Width of pressing roll: Wpr=380 mm

Experiment conditions

Total load applied to the pressing roll=300 kgf

Total load applied to the peeling pad=30 kgf

Temperature of fixing belt=150° C.

Process speed ˜264 mm/s

Text method

The evaluation items were checked after idle rotation for 5 hours in the nip state.

Evaluation Items (Observed Visually)

1. Wear and damage on the inner face of the fixing belt due to both edges of the peeling pad

2. Wear and damage on the surface of the pressing roll due to both edges of the peeling pad

3. Presence or absence of wear and damage on the surface of the pressing roll when the peeling pad directly slides with the pressing roll

The items 2 and 3 are unified as the wear and damage on the surface of the pressing roll in the evaluation column of the table.

TABLE 2

| | | Configurational |
|---|---|---|
| | Comparative | example of the |
| | Example | invention |
| | (With walk) | (With walk) |
| Wear and damage on inner face of | x | ∘ |
| fixing belt | | |
| Wear and damage on surface of | x | ∘ |
| pressing roll | | |

The configurational conditions are as follows, and other experiment conditions, the test method and the evaluation items are the same as the above test.

Configurational example of the invention satisfying the above relational expression

Width of peeling pad: Wpe 380 mm

Width of fixing belt: Wbe 360 mm

Width of pressing roll: Wpr=340 nm

Maximum width of belt walk on one side: Bw=10 mm Comparative example not satisfying the above relational expression

Width of peeling pad: Wpe=380 mm

Width of fixing belt; Wbe=360 mm

Width of pressing roll: Wpr ˜340 mm

Maximum width of belt walk on one side: Bw=30 mm

As a result, wear and damage occurred after idle rotation for 5 hours in the nip state leading to use unsuitable condition in the comparative example, while wear and damage were not observed in the configurational example of the invention, as listed in Tables 1 and 2. Thereby, the effect of suppressing the wear and damage of the fixing belt 610 and the pressing roll 62 in the fixing device 60 could be confirmed.

As described above, since the fixing device 60 of this embodiment employs, as the heating member, the fixing belt module 61 in which the fixing belt 610 is stretched around plural rolls including the fixing roll 611, a predetermined fixing temperature can be maintained in the fixing device 60 at any time, even if the image forming apparatus is made faster. Moreover, it is possible to suppress occurrence of a temperature droop phenomenon that the fixing temperature falls at the time of starting the fast fixing operation. Therefore, a large amount of high quality fixed images can be produced in a short time.

Also, it is possible to prevent the wear of the fixing belt 610 or the pressing roll 62 due to the peeling pad 64 having adverse influence on the fixing performance, whereby the high fixing performance can be maintained for the long term.

This invention is not limited to the above embodiment. Though the invention is applied to the color image forming apparatus of so-called tandem type in this embodiment, the invention may be applied to the color image forming apparatus using a rotary developing device or the monochrome copying machine.

Though the pressing roll 62 is employed as the pressing having pressed and contacted with the fixing belt module 61, the invention may be applied to a pressing belt module in which the pressing belt is stretched around plural rolls as the pressing member.

According to the fixing device, it is possible to suppress the wear of the fixing belt or the pressing roll due to the peeling member having an adverse influence on the fixing performance, whereby the high fixing performance can be maintained stably for the long term. Accordingly, the fixing device having high durability can be obtained.

Moreover, according to the image forming apparatus, it is possible to suppress the wear having an adverse influence on the fixing performance of the fixing device, whereby the high fixing performance can be maintained stably for the long term. Accordingly, the image forming apparatus having high durability in which a large amount of images of good quality can be provided in a short time.

As described so far, according to an aspect of the present invention, a fixing device which fixes a toner image borne on a recording medium includes a rotatable fixing roll member, a rotatable tension roll member, a rotating fixing belt member stretched between the fixing roll member and the tension roll member, a heater which heats the fixing belt member, a pressing member which presses a portion of the fixing roll member around which the fixing belt member is wound to form a nip part, and a belt moving direction changing member which is interposed between the fixing belt member and the fixing roll member on a downstream side of the nip part, and changes a moving direction of the fixing belt member. Width “Wbe” of the fixing belt member, width “Wpr” of the pressing member, and width “Wpe” of the belt moving direction changing member are set to satisfy the following relation: Wpr≦Wbe<Wpe.

The pressing member may be a pressing roll member having an elastic layer on its surface.

The fixing device may further include a walk section which causes the fixing belt member to walk. A walk rate “Bw” of the fixing belt member by the walk section is set to satisfy the following relation: Bw<(Wpe−Wpr)/2.

Width “Lhr” of the fixing roll member may be set to satisfy the following relation: Wbe<Lhr≦Wpe.

According to another aspect of the present invention, a fixing device which fixes a toner image borne on a recording medium includes a rotatable fixing roll member, a rotatable tension roll member, a rotating fixing belt member stretched between the fixing roll member and the tension roll member, a pressing roll member which presses a portion of the fixing roll member around which the fixing belt member is wound to form a nip part, the pressing roll member having an elastic layer on its surface, and a bending member formed of metal which is interposed between the fixing belt member and the fixing roll member on a downstream side of the nip part, and bends the fixing belt member at a greater curvature. The bending member and the pressing roll member are not directly contacted owing to the belt member interposed between the bending member and the pressing roll member, even when the fixing belt member walks.

A side edge of the fixing belt member may not protrude out of a side edge of the bending members even when the fixing belt member walks.

According to still another aspect of the present invention, an image forming apparatus includes a toner image forming section which forms a toner image, a transfer section which transfers the toner image formed by the toner image forming section onto a recording medium, and a fixing device which fixes the toner image transferred onto the recording medium on the recording medium. The fixing device includes a rotatable fixing roll member, a rotatable tension roll member having a thermal heater, a rotating fixing belt member stretched between the fixing roll member and the tension roll member, a pressing roll member which presses a portion of the fixing roll member around which the fixing belt member is wound to form a nip part, the pressing roll member having an elastic layer on its surface, and a peeling member which is interposed between the fixing belt member and the fixing roll member on a downstream side of the nip part, and peels the recording medium from the fixing belt member. Width “Wbe” of the fixing belt member, width “Wpr” of the pressing roll member, and width “Wpe” of the peeling member are set to satisfy the following relation: Wpr≦Wbe<Wpe.

The image forming apparatus may further include a walk section which causes the fixing belt member to walk. A walk rate “Bw” of the fixing belt member by the walk section may be set to satisfy the following relation: Bw<(Wpe−Wpr)/2.

Width “Lhr” of the fixing roll member may be set to satisfy the following relation: Wbe<Lhr≦Wpe.

According to still another aspect of the present invention, a fixing device which fixes a toner image borne on a recording medium includes a rotational member, an endless belt member which is wound around the rotational member and rotates along with a rotation of the rotational member, a pressing member which presses the rotational member and the belt member wound around the rotational member to form a nip part, and a belt moving direction changing member which is interposed between the belt member and the rotational member on a downstream side of the nip part, and changes a moving direction of the belt member. Wdth “Wbe” of the belt member, width “Wpr” of the pressing member, and width “Wpe” of the belt moving direction changing member are set to satisfy the following relation: Wpr≦Wbe<Wpe.

What is claimed is:

1. A fixing device which fixes a toner image borne on a recording medium, comprising:
a rotatable fixing roll member;
a rotatable tension roll member;
a rotating fixing belt member stretched between the fixing roll member and the tension roll member;
a heater which heats the fixing belt member;
a pressing member which presses a portion of the fixing roll member around which the fixing belt member is wound to form a nip part; and
a belt moving direction changing member which is interposed between the fixing belt member and the fixing roll member on a downstream side of the nip part, and changes a moving direction of the fixing belt member,
wherein width “Wbe” of the fixing belt member, width “Wpr” of the pressing member, and width “Wpe” of the belt moving direction changing member are set to satisfy the following relation:
Wpr≦Wbe<Wpe.

2. The fixing device according to claim 1,
wherein the pressing member is a pressing roll member having an elastic layer on its surface.

3. The fixing device according to claim 1, further comprising:
a walk section which causes the fixing belt member to walk,
wherein a walk rate “Bw” of the fixing belt member by the walk section is set to satisfy the following relation;
Bw<(Wpe−Wpr)/2.

4. The fixing device according to claim 1,
wherein width “Lhr” of the fixing roll member is set to satisfy the following relation:
Wbe<Lhr≦Wpe.

5. A fixing device which fixes a toner image borne on a recording medium, comprising:
a rotatable fixing roll member;
a rotatable tension roll member;
a rotating fixing belt member stretched between the fixing roll member and the tension roll member;
a pressing roll member which presses a portion of the fixing roll member around which the fixing belt member is wound to form a nip part, the pressing roll member having an elastic layer on its surface; and
a bending member formed of metal which is interposed between the fixing belt member and the fixing roll member on a downstream side of the nip part, and bends the fixing belt member at a greater curvature,
wherein the bending member and the pressing roll member are not directly contacted owing to the belt member interposed between the bending member and the pressing roll member, even when the fixing belt member walks.

6. The fixing device according to claim 5,
wherein a side edge of the fixing belt member does not protrude out of a side edge of the bending member, even when the fixing belt member walks.

7. An image forming apparatus, comprising:
a toner image forming section which forms a toner image;
a transfer section which transfers the toner image formed by the toner image forming section onto a recording medium; and
a fixing device which fixes the toner image transferred onto the recording medium on the recording medium,
wherein the fixing device includes:
a rotatable fixing roll member;
a rotatable tension roll member having a thermal heater;
a rotating fixing belt member stretched between the fixing roll member and the tension roll member;
a pressing roll member which presses a portion of the fixing roll member around which the fixing belt member is wound to form a nip part, the pressing roll member having an elastic layer on its surface; and
a peeling member which is interposed between the fixing belt member and the fixing roll member on a downstream side of the nip part, and peels the recording medium from the fixing belt member,
wherein width “Wbe” of the fixing belt member, width “Wpr” of the pressing roll member, and width “Wpe” of the peeling member are set to satisfy the following relation:
Wpr≦Wbe<Wpe.

8. The image forming apparatus according to claim 7, further comprising:
a walk section which causes the fixing belt member to walk,
wherein a walk rate “Bw” of the fixing belt member by the walk section is set to satisfy the following relation:
Bw<(Wpe−Wpr)/2.

9. The image forming apparatus according to claim 7,
wherein width “Lhr” of the fixing roll member is set to satisfy the following relation:
Wbe<Lhr≦Wpe.

10. A fixing device which fixes a toner image borne on a recording medium, comprising:
a rotational member;
an endless belt member which is wound around the rotational member and rotates along with a rotation of the rotational member;
a pressing member which presses the rotational member and the belt member wound around the rotational member to form a nip part; and
a belt moving direction changing member which is interposed between the belt member and the rotational member on a downstream side of the nip part, and changes a moving direction of the belt member,
wherein width “Wbe” of the belt member, width “Wpr” of the pressing member, and width “Wpe” of the belt moving direction changing member are set to satisfy the following relation:
Wpr≦Wbe<Wpe.
